(19) United States
(12) Patent Application Publication
(10) Pub. No.: US 2026/0279683 A1
(43) Pub. Date: Sep. 17, 2026

(54) MULTILAYER CERAMIC CAPACITOR

(71) Applicant: TAIYO YUDEN CO., LTD., Tokyo (JP)

(72) Inventor: Ryo ITO, Tokyo (JP)

(21) Appl. No.: 19/552,176

(22) Filed: Feb. 27, 2026

(30) Foreign Application Priority Data
Mar. 13, 2025 (JP) 2025-040206

(51) Int. Cl. H01G 4/30; H01G 4/12

(52) U.S. Cl. CPC H01G 4/30; H01G 4/1227

(57) ABSTRACT

A multilayer ceramic capacitor includes: an element body in which a dielectric layer and an internal electrode layer are alternately laminated in a first axis direction, in which the dielectric layer includes: a perovskite compound represented by a general formula ABO₃; and acicular particles containing silicon (Si) and aluminum (Al), a thickness of the dielectric layer is 0.6 μm or less, and a proportion (number ratio) of acicular particles satisfying Expression I to a total of the included acicular particles ranges from 45% to 65%, inclusive,

$$0 ° \leq θ < 30 ° \qquad Expression I$$

where θ is an acute angle formed between a line segment parallel to a direction perpendicular to the first axis direction and a line segment parallel to a longitudinal direction of each of the acicular particles, in a cross-sectional view of the multilayer ceramic capacitor taken along the first axis direction.

### CROSS-REFERENCE TO RELATED APPLICATIONS

This application is based upon and claims priority to Japanese Patent Application No. 2025-040206 filed on Mar. 13, 2025, the entire contents of which are incorporated herein by reference.

### BACKGROUND OF THE INVENTION

### 1. Field of the Invention

The present disclosure relates to a multilayer ceramic capacitor.

### 2. Description of the Related Art

A multilayer ceramic capacitor (MLCC) has a structure in which dielectric layers and internal electrode layers are alternately laminated. Such multilayer ceramic capacitors are used in various electronic devices, such as mobile phones and personal computers.

In recent years, as electronic devices using multilayer ceramic capacitors have become increasingly multifunctional and higher in performance, there has been a demand for multilayer ceramic capacitors having a smaller size, higher strength, and the like. To meet such demands, it is effective to increase the number of laminated layers by reducing the thicknesses of the dielectric layers and the internal electrode layers, or to enhance strength by adding acicular particles containing silicon (Si) and aluminum (Al) to the dielectric layers (see, for example, Japanese Patent Application Laid-Open Publication No. 2023-042562).

However, in multilayer ceramic capacitors in the related art, including those described above, as the dielectric layers and the internal electrode layers are reduced in thickness, acicular particles are likely to penetrate the internal electrodes and extend across a plurality of layers. In such a structure, the acicular particles may interfere with and deform the internal electrodes, thereby reducing the distance between adjacent internal electrodes and possibly causing electrical characteristic abnormalities such as short circuits. In addition, in the dielectric layers having reduced thickness, grain growth may progress to form coarse grains, resulting in a reduced number of grain boundaries in the vicinity of such grains and possibly leading to a reduced lifetime.

### SUMMARY OF THE INVENTION

According to an aspect of the present disclosure, a multilayer ceramic capacitor includes:
an element body in which a dielectric layer and an internal electrode layer are alternately laminated in a first axis direction, in which
the dielectric layer includes: a perovskite compound represented by a general formula ABO₃; and acicular particles containing silicon (Si) and aluminum (Al),
a thickness of the dielectric layer is 0.6 μm or less, and
a proportion (number ratio) of acicular particles satisfying Expression I to a total of the included acicular particles ranges from 45% to 65%, inclusive.

$$0 ° \leq θ < 30 ° \qquad Expression I$$

where θ is an acute angle formed between a line segment parallel to a direction perpendicular to the first axis direction and a line segment parallel to a longitudinal direction of each of the acicular particles, in a cross-sectional view of the multilayer ceramic capacitor taken along the first axis direction.

### BRIEF DESCRIPTION OF THE DRAWINGS

FIG. 1 is a perspective view showing a multilayer ceramic capacitor according to an embodiment of the present disclosure;

FIG. 2 is a cross-sectional view taken along a line A-A in FIG. 1;

FIG. 3 is a cross-sectional view taken along a line B-B in FIG. 1;

FIG. 4 is a schematic view for explaining the shape of acicular particles in the multilayer ceramic capacitor according to an embodiment of the present disclosure;

FIG. 5A is an enlarged schematic view of a region C in FIG. 2;

FIG. 5B is a schematic view for explaining an example of θ; and

FIG. 6 is a flowchart illustrating a method for manufacturing a multilayer ceramic capacitor according to an embodiment.

### DESCRIPTION OF THE EMBODIMENTS

The present disclosure provides a multilayer ceramic capacitor with high strength and excellent electrical characteristics.

Hereinafter, embodiments of the present disclosure will be described in detail. Each embodiment may hereinafter be referred to as “the present embodiment”; however, the present disclosure is not limited thereto. In this specification and the drawings, components having substantially the same functional configurations are denoted by the same reference signs, and repeated descriptions thereof may be omitted. In the drawings, mutually orthogonal x-axis, y-axis, and z-axis are shown as appropriate. The x-axis, the y-axis, and the z-axis define a fixed coordinate system for a multilayer ceramic capacitor. When a multilayer ceramic capacitor, an example of a multilayer ceramic electronic component, has a substantially rectangular parallelepiped external shape, the x-axis, the y-axis, and the z-axis may correspond to the length, width, and height of the multilayer ceramic capacitor, respectively.

### [Basic Structure of Multilayer Ceramic Capacitor]

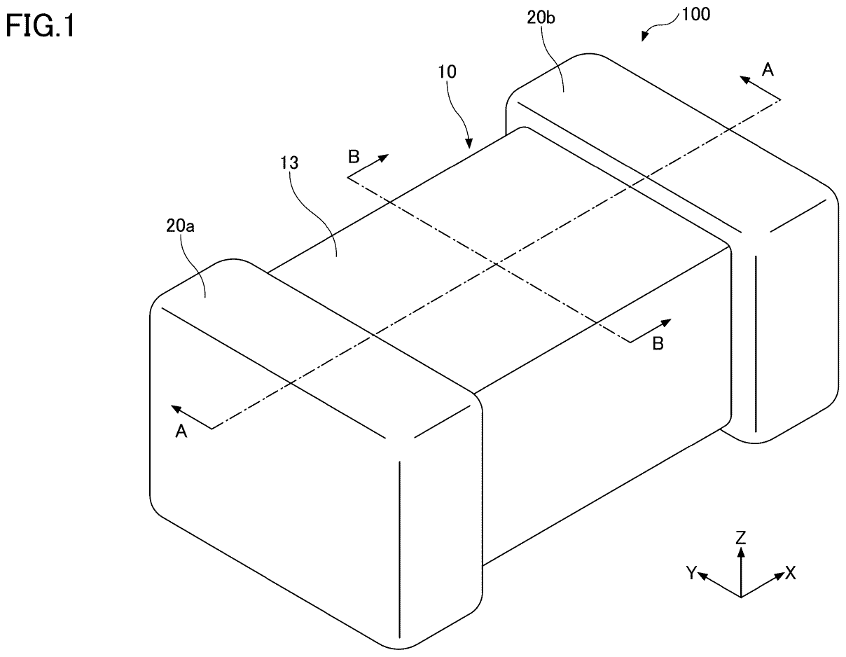

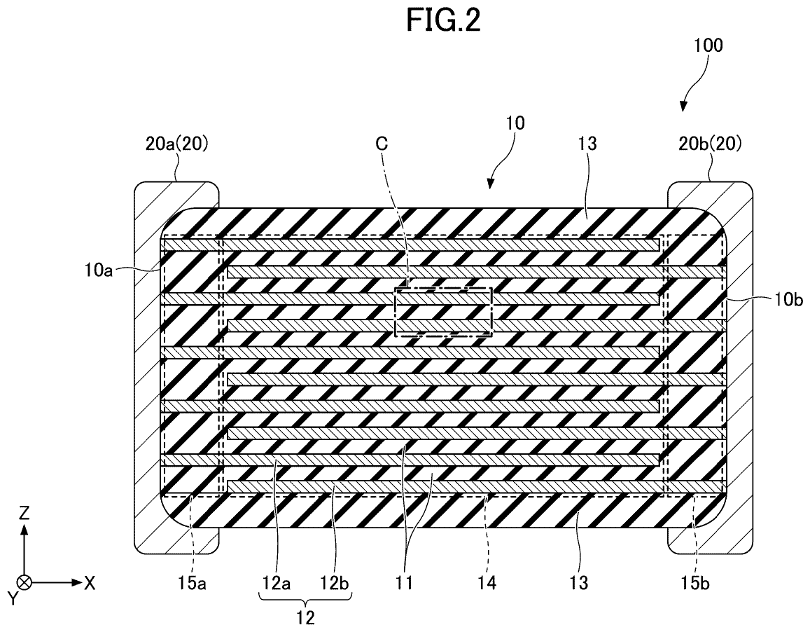

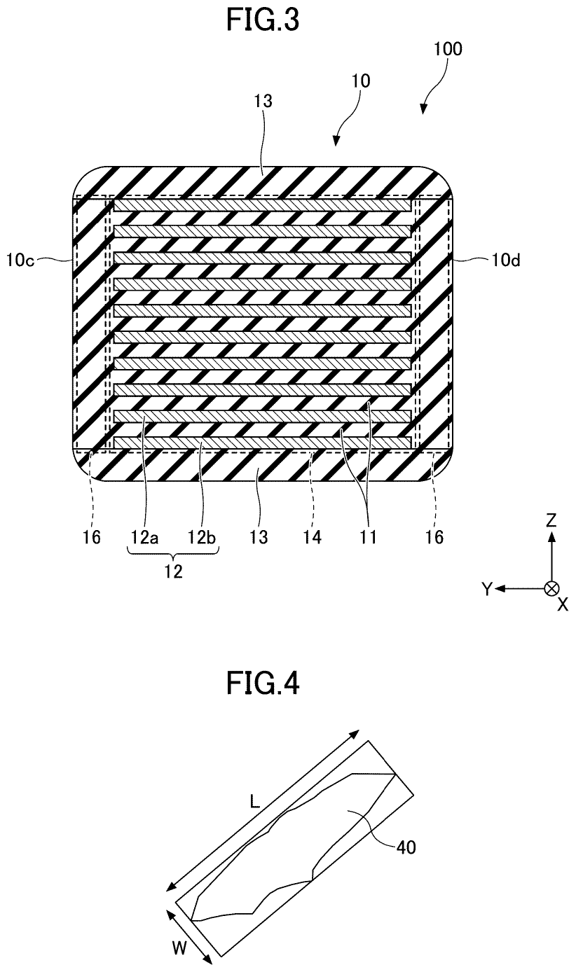

FIG. 1 is a perspective view showing a multilayer ceramic capacitor 100 according to an embodiment of the present disclosure. FIG. 2 is a cross-sectional view taken along a line A-A in FIG. 1. FIG. 3 is a cross-sectional view taken along a line B-B in FIG. 1.

As shown in FIGS. 1 to 3, a multilayer ceramic capacitor 100 includes an element body 10 having a substantially rectangular parallelepiped shape. In the element body 10, two opposing surfaces are referred to as a top surface and a bottom surface, and four surfaces connecting the top surface and the bottom surface are each referred to as a side surface. Typically, the surface facing a circuit board when the multilayer ceramic capacitor is mounted thereon is referred to as the bottom surface; however, the bottom surface is not limited thereto.

In an example shown in FIGS. 1 to 3, a first external electrode 20a and a second external electrode 20b are provided on a first side surface 10a and a second side surface 10b (see FIG. 2), respectively, which are two opposing side surfaces of the element body 10.

The first external electrode 20a extends from the first side surface 10a to four surfaces adjacent to the first side surface 10a. The second external electrode 20b extends from the second side surface 10b to four surfaces adjacent to the second side surface 10b. The first external electrode 20a and the second external electrode 20b are spaced apart from each other. The external electrodes may be provided on surfaces of the element body 10 other than the two opposing side surfaces.

The element body 10 includes dielectric layers 11 and internal electrode layers 12 alternately laminated in a first axis direction. The dielectric layers 11 contain acicular particles and a ceramic material that functions as a dielectric.

The internal electrode layers 12 include a plurality of first internal electrode layers 12a and a plurality of second internal electrode layers 12b. The first internal electrode layers 12a and the second internal electrode layers 12b are alternately laminated in the first axis direction. The end edges of the first internal electrode layers 12a are extended to the surface of the element body 10 on which the first external electrode 20a is provided, that is, the first side surface 10a in FIGS. 1 to 3. The end edges of the second internal electrode layers 12b are extended to the surface of the element body 10 on which the second external electrode 20b is provided, that is, the second side surface 10b in FIGS. 1 to 3. Accordingly, the first internal electrode layers 12a and the second internal electrode layers 12b, which are alternately laminated, are electrically connected to the first external electrode 20a and the second external electrode 20b, respectively. Thus, the multilayer ceramic capacitor 100 has a laminated structure in which a plurality of capacitor elements are formed. Note that the number of dielectric layers 11 and the number of internal electrode layers 12 in FIGS. 1 to 3 are merely examples for facilitating the explanation, and the multilayer ceramic capacitor according to the present embodiment may include a larger number of laminated layers.

The laminating direction in which the dielectric layers 11 and the internal electrode layers 12 are laminated is the first axis direction. As shown in FIGS. 1 to 3, when the first axis direction, which is the laminating direction, corresponds to a direction along the Z-axis (Z-axis direction) in a fixed coordinate system, the Z-axis defines the laminating direction of the dielectric layers 11 and the internal electrode layers 12, and also defines a direction in which the internal electrode layers 12 oppose each other.

An axis perpendicular to the first axis, which is the laminating direction, is referred to as a second axis. As shown in FIGS. 1 to 3, when the second axis perpendicular to the first axis (the laminating direction) corresponds to a direction along the X-axis (X-axis direction), the X-axis defines a direction in which the internal electrode layers 12 are led out, and also defines a direction in which the first side surface 10a and the second side surface 10b of the element body 10 oppose each other, or a direction in which the first external electrode 20a and the second external electrode 20b oppose each other. In the example shown in FIGS. 1 to 3, the electrode led-out direction (X-axis direction) corresponds to a direction along a longitudinal direction of the element body 10.

An axis perpendicular to both the first axis (the laminating direction) and the second axis is referred to as a third axis. As shown in FIGS. 1 to 3, when a third axis perpendicular to both the first axis (the laminating direction) and the second axis corresponds to a direction along the Y-axis (Y-axis direction), the Y-axis defines a direction in which a third side surface 10c and a fourth side surface 10d of the four side surfaces of the element body 10 oppose each other. In the example shown in FIGS. 1 to 3, the Y-axis direction corresponds to a direction along a width direction of the element body 10.

The X-axis direction, the Y-axis direction, and the Z-axis direction are orthogonal to one another. The laminating direction is not limited to the Z-axis direction, and may be set to any axis direction. Accordingly, for example, the first axis serving as the laminating direction may be the X-axis that defines the X-axis direction or the Y-axis that defines the Y-axis direction.

In this specification, drawings illustrating, as an example, a specific embodiment may be used for describing general embodiments. However, descriptions given with reference to a coordinate axis system used in such a specific embodiment are to be understood as being applicable to a general coordinate system in which the laminating direction is defined as the first axis in the general embodiments. For example, in FIGS. 1 to 3, which illustrate a specific embodiment in which the laminating direction coincides with the Z-axis direction, the X-axis, the Y-axis, and the Z-axis may be read as the second axis, the third axis, and the first axis, respectively, in the general embodiments.

A region in which the first internal electrode layers 12a connected to the first external electrode 20a and the second internal electrode layers 12b connected to the second external electrode 20b oppose each other is referred to as a capacitance portion 14. The capacitance portion 14 is a region in which electric capacitance is generated in the multilayer ceramic capacitor 100. In other words, the capacitance portion 14 is a region in which the internal electrode layers, which are connected to different external electrodes and adjacent to each other with a dielectric layer interposed therebetween, oppose each other.

Outermost layers of the capacitance portion 14, which is formed by laminating the dielectric layers 11 and the internal electrode layers 12, are the internal electrode layers 12 in the laminating direction (Z-axis direction). Cover layers 13 may be disposed on outer surfaces of the capacitance portion 14 in the laminating direction, that is, on outer surfaces of the outermost internal electrode layers 12 in the laminating direction.

The cover layers 13 are layers containing a ceramic material that functions as a dielectric, and may have the same composition as the dielectric layers 11 or may have a different composition.

The configuration of the element body 10 is not limited to those shown in FIGS. 1 to 3 provided that the first internal electrode layers 12a and the second internal electrode layers 12b are exposed at different regions of the surfaces of the element body 10 and are electrically connected to different external electrodes. The different regions of the surfaces of the element body 10 may be surface regions of the surfaces opposing each other among the surfaces of the element body 10, may be surface regions of surfaces adjacent to each other, or may be different surface regions of one surface. Provided that the different external electrodes are spaced apart from each other, the first internal electrode layers 12a and the second internal electrode layers 12b may extend from surfaces, on which the first internal electrode layers 12a and the second internal electrode layers 12b are exposed at the surface regions, to other surfaces of the multilayer body.

A region in which the first internal electrode layers 12a connected to the first external electrode 20a oppose each other in the laminating direction without the second internal electrode layers 12b connected to the second external electrode 20b interposed therebetween is referred to as a first end margin 15a. A region in which the second internal electrode layers 12b connected to the second external electrode 20b oppose each other in the laminating direction without the first internal electrode layers 12a connected to the first external electrode 20a interposed therebetween is referred to as a second end margin 15b. Each end margin is a region in which the internal electrode layers connected to the same external electrode oppose each other in the laminating direction without the internal electrode layers connected to a different external electrode interposed therebetween. The first end margin 15a and the second end margin 15b are regions in which no electric capacitance is generated.

As shown in FIG. 3, regions provided adjacent to outer sides of the capacitance portion 14 in the Y-axis direction are referred to as side margins 16. The side margins 16 are outer regions adjacent to the sides of the capacitance portion 14 on which the internal electrode layers 12 are not led out. The side margins 16 are regions in which no electric capacitance is generated.

The size of the multilayer ceramic capacitor 100 is not particularly limited and may be selected as appropriate depending on the intended purpose. For example, the multilayer ceramic capacitor 100 may have: a length of 0.25 mm, a width of 0.125 mm, and a height of 0.125 mm; a length of 0.4 mm, a width of 0.2 mm, and a height of 0.2 mm; a length of 0.6 mm, a width of 0.3 mm, and a height of 0.3 mm; a length of 1.0 mm, a width of 0.5 mm, and a height of 0.5 mm; a length of 3.2 mm, a width of 1.6 mm, and a height of 1.6 mm; or a length of 4.5 mm, a width of 3.2 mm, and a height of 2.5 mm. However, the above-described sizes of the multilayer ceramic capacitor 100 are merely examples, and the multilayer ceramic capacitor 100 is not limited to these sizes.

The size of the multilayer ceramic capacitor 100 may be, for example, such that the length is greater than the width, which is equal to or greater than the height; the width is greater than the length, which is equal to or greater than the height; the height is greater than the length, which is equal to or greater than the width; or the height is greater than the width, which is equal to or greater than the length. Note that, in the multilayer ceramic capacitor 100 shown in FIGS. 1 to 3, the length is defined along the X-axis direction (the electrode led-out direction), the width is defined along the Y-axis direction, and the height is defined along the Z-axis direction (the laminating direction).

### (Dielectric Layer)

### <Perovskite Compound>

The dielectric layers 11 contain, as a main component, a compound having a perovskite structure represented by the general formula ABO₃ (also referred to as a perovskite compound). Note that, in this specification, the expression “containing a predetermined component as a main component” means that the predetermined component is present in the largest amount among the components contained.

The perovskite compound content of the dielectric layers 11 is not particularly limited and may be selected as appropriate depending on the intended purpose. For example, the perovskite compound may be contained in an amount of 50 atomic % or more, 60 atomic % or more, 80 atomic % or more, 90 atomic % or more, or 95 atomic % or more. Note that the perovskite structure may be oxygen-deficient relative to a stoichiometric composition. That is, the perovskite compound may be represented by ABO_{3-α}, where 0≤α≤1, and α represents a deviation from the stoichiometric composition.

Examples of the perovskite compound include one or more of barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-z}Zr_{z}O₃ (0≤x≤1, 0≤y≤1, 0≤z≤1), which form a perovskite structure.

Specific examples of the compound represented by Ba_{1-x-y}CaₓSr_{y}Ti_{1-z}Zr_{z}O₃ include barium strontium titanate, barium calcium titanate, barium zirconate, barium zirconate titanate, calcium zirconate titanate, and barium calcium zirconate titanate.

Among these perovskite compounds, barium titanate (BaTiO₃) is preferable in terms of excellent dielectric properties, such as a high dielectric constant and a low dielectric loss. When the dielectric layers 11 contain barium titanate as the perovskite compound, the electrostatic capacitance of the multilayer ceramic capacitor 100 can be increased. The ceramic material of the dielectric layers 11 preferably contains barium titanate as the main component, and may be composed solely of barium titanate.

Barium titanate can generally be produced by reacting a titanium source (e.g., titanium dioxide) with a barium source (e.g., barium carbonate).

A method for synthesizing a ceramic powder serving as a ceramic material that constitutes the main component of the dielectric layers 11 is not particularly limited and may be selected as appropriate depending on the intended purpose. For example, the method may include a solid-phase method, a sol-gel method, and a hydrothermal method.

### <Acicular Particles>

The dielectric layers 11 include acicular particles containing silicon (Si) and aluminum (Al). With the dielectric layers 11 including the acicular particles, the strength of the multilayer ceramic capacitor is improved. In addition, during a firing step described later, the presence of the acicular particles between particles in the element body suppresses necking between the particles and suppresses grain growth, and thus the sintering is stabilized.

In this specification, the term “acicular particle” refers to a particle having a length L ranging from 0.05 μm to 5 μm, inclusive, and an aspect ratio (L/W) of 3 or more. The length L and the aspect ratio (L/W) are determined, as shown in FIG. 4, based on a circumscribed rectangle of the target particle in a cross-sectional view, in which a long side of the rectangle is defined as L and a short side is defined as W.

A method for identifying acicular particles 40 in the dielectric layers 11 is not particularly limited and may be selected as appropriate depending on the intended purpose. For example, the following method may be employed. A partial cross section including an internal electrode layer in a YZ plane or an XZ plane of the multilayer ceramic capacitor is observed using a scanning electron microscope (SEM) capable of identifying a composition of a sample based on a backscattered electron image. From a contrast difference in the backscattered electron image, acicular particles having a composition different from that of the dielectric can be identified. Before observation with the SEM, the multilayer ceramic capacitor may be processed, for example, by ion milling to obtain a smooth cross section suitable for observation. From the obtained backscattered electron image, a particle length L and an aspect ratio (L/W) of the particles are measured using, for example, image analysis software such as ImageJ.

The composition of the acicular particles 40 is not particularly limited and may be selected as appropriate depending on the intended purpose, provided that the acicular particles 40 contain silicon (Si) and aluminum (Al). Specific examples include 3Al₂O₃·2SiO₂ and Al₂SiO₇.

In the multilayer ceramic capacitor of the present embodiment, the proportion of acicular particles satisfying Expression I to the total acicular particles ranges from 45% to 65%, inclusive. In other words, in the multilayer ceramic capacitor of the present embodiment, the number ratio of the acicular particles satisfying Expression I to the total number of acicular particles contained in the dielectric layers ranges from 45% to 65%, inclusive.

$$0 ° \leq θ < 30 ° \qquad Expression I$$

where θ is an acute angle formed between a line segment parallel to a direction perpendicular to the first axis direction and a line segment parallel to a longitudinal direction of each of the acicular particles, in a cross-sectional view of the multilayer ceramic capacitor taken along the first axis direction.

In this specification, the “cross-sectional view of the multilayer ceramic capacitor taken along the first axis direction” may be a YZ cross section as shown in FIG. 2 or an XZ cross section as shown in FIG. 3. The “longitudinal direction of the acicular particle” in Expression I refers to the long side direction (length direction) L of an acicular particle 40, as shown in FIG. 4. The “direction perpendicular to the first axis direction” in Expression I is not particularly limited and may be selected as appropriate depending on the intended purpose, provided that the direction is perpendicular to the first axis direction. However, the direction is preferably the second axis direction or the third axis direction.

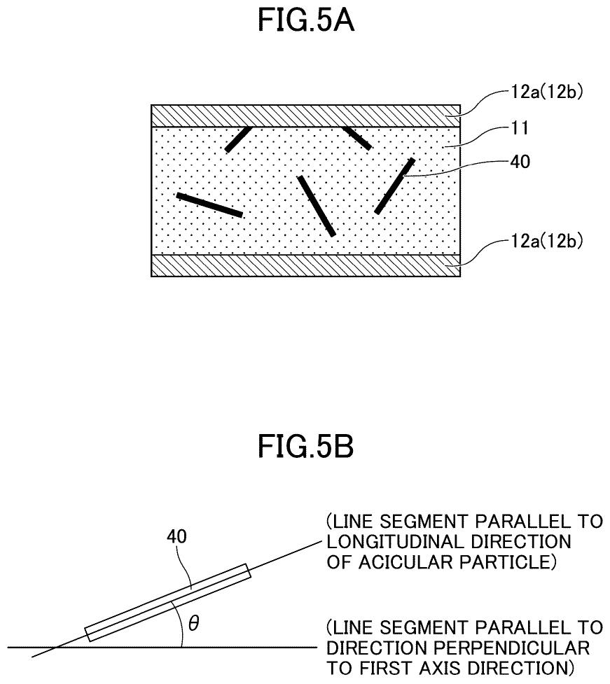

A more specific description will be given with reference to FIGS. 5A and 5B. FIG. 5A is an enlarged schematic view of a region C in FIG. 2, and FIG. 5B is a schematic view for explaining an example of θ. In FIG. 5A, for ease of explanation, particles having a perovskite structure present in the dielectric layers 11 are omitted, and acicular particles 40 are schematically shown in a linear shape. The acicular particles 40 are present between the particles having a perovskite structure. As will be described in detail later, the dielectric layers 11 are formed of a dielectric-layer-forming powder (or a dielectric-layer-forming slurry) containing a perovskite compound and acicular particles, and the acicular particles 40 are dispersed in the dielectric layers 11. In the multilayer ceramic capacitor according to the present embodiment, the proportion (number ratio) of the acicular particles 40 satisfying Expression I to the total acicular particles 40 dispersed in the dielectric layers 11 ranges from 45% to 65%, inclusive. In other words, in a cross-sectional view of the multilayer ceramic capacitor 100 taken along the first axis direction, the proportion (number ratio) of the acicular particles 40 for which an acute angle θ formed between a line segment parallel to a direction perpendicular to the first axis direction and a line segment parallel to a longitudinal direction of the acicular particle 40 is from 0° to less than 300 ranges from 45% to 65%, inclusive, among the total acicular particles 40.

In the multilayer ceramic capacitor according to the present embodiment, the proportion of the acicular particles satisfying Expression I to the total acicular particles preferably ranges from 55% to 65%, inclusive, and more preferably ranges from 60% to 65%, inclusive. When the proportion of the acicular particles satisfying Expression I is 45% or more, electrical characteristics such as a short-circuit rate and a lifetime of the multilayer ceramic capacitor are improved, which is preferable. When the proportion of the acicular particles satisfying Expression I is 65% or less, the strength and the electrostatic capacitance of the multilayer ceramic capacitor are improved, which is preferable.

In this specification, the term “high strength” refers to a state in which a multilayer ceramic capacitor after firing exhibits, for example, a small number of cracks, a small number of short circuits, a high yield, and a low failure rate in a deflection test. In addition, in this specification, the term “excellent electrical characteristics” refers to characteristics in which the multilayer ceramic capacitor exhibits, for example, a large electrostatic capacitance and a long lifetime.

In the multilayer ceramic capacitor according to the present embodiment, when the proportion of the acicular particles satisfying Expression I to the total acicular particles ranges from 45% to 65%, inclusive, penetration of the acicular particles through an internal electrode layer, which could occur in conventional multilayer ceramic capacitors, can be suppressed, and thus characteristics such as yield, short-circuit rate, and lifetime are improved.

The proportion of the acicular particles satisfying Expression I can be controlled, for example, based on the amount of the acicular particles 40 contained in a dielectric-layer-forming powder used to form the dielectric layers 11, the viscosity of a dielectric-layer-forming slurry, the coating speed of the dielectric-layer-forming slurry, and the thickness of a ceramic green sheet. When the coating speed of the dielectric-layer-forming slurry is high, a shearing force is increased, and thus control of an orientation of the acicular particles 40 is facilitated. By reducing the thickness of the ceramic green sheet, that is, by narrowing a gap of a discharge port of a coating apparatus, the dielectric-layer-forming slurry passes through a narrow gap, and thus control of an orientation of the acicular particles 40 is facilitated.

In the dielectric-layer-forming powder, the total amount of acicular particles contained, including acicular particles satisfying Expression I and acicular particles not satisfying Expression I, preferably ranges from 0.5 mass % to 3 mass %, inclusive, of the total amount of the dielectric-layer-forming powder, to obtain a multilayer ceramic capacitor with high strength and excellent electrical characteristics.

A method for synthesizing the acicular particles 40 is not particularly limited and may be selected as appropriate depending on the intended purpose. For example, the following method may be employed. A source powder and an ethanol solution are ball-milled with zirconia beads. Thereafter, the zirconia beads are separated by sieving or the like, and the mixture is dried at 100° C. to remove ethanol, thereby obtaining a mixed powder. The mixed powder is subjected to heat treatment under an air atmosphere at a temperature of 1,100° C. to 1,400° C. for a heat retention time of 30 minutes to 20 hours to obtain the acicular particles 40. A size of the acicular particles 40 can be adjusted as appropriate by controlling a composition of the source powder, the heat treatment temperature, the heat retention time, and the like. Examples of materials contained in the source powder are as follows.

$$- Source Powder -$$

$${SiO}_{2} : {Al}_{2} {O}_{3} : {TiO}_{2} : {CaCO}_{3} : {Na}_{2} {CO}_{3} : {K}_{2} {CO}_{3} = 1 : 1.2 : 0.01 : 0.002 : 0.005 : 0.003 ( mol \% )$$

The dielectric-layer-forming powder may contain spherical particles in addition to the perovskite compound and the acicular particles 40. In this specification, the term “spherical particles” include particles having an aspect ratio (L/W) of less than 3. A long side L and a short side W of each spherical particle are determined by the same method used for the acicular particles described above.

The spherical particles are not particularly limited and may be selected as appropriate depending on the intended purpose, but preferably contain silicon (Si) and aluminum (Al). Specific compositions of the spherical particles include, for example, Al₂Si₂O₅ and Al₄Si₈O₂₂.

A ratio of the acicular particles to the spherical particles [acicular particles:spherical particles] in the dielectric-layer-forming powder preferably ranges from 10:90 to 90:10, inclusive, and more preferably ranges from 20:80 to 60:40, inclusive, to obtain a multilayer ceramic capacitor with high strength and excellent electrical characteristics.

A method for measuring the amount of acicular particles satisfying Expression I is not particularly limited and may be selected as appropriate depending on the intended purpose. For example, the amount may be evaluated based on cross-sectional observation of the multilayer ceramic capacitor 100. More specifically, the following method may be employed. The multilayer ceramic capacitor is polished along the X-axis direction or the Y-axis direction to expose a YZ plane or an XZ plane of the capacitance portion 14. In this case, the position of the plane exposed by polishing is preferably located near the center of the capacitance portion 14 in the X-axis direction or the Y-axis direction. On the exposed plane, approximately three dielectric layers 11 are selected from each of a central portion, an upper end portion, and a lower end portion in the Z-axis direction (the laminating direction of the dielectric layers 11), thereby selecting nine dielectric layers 11 in total. In each selected dielectric layer 11, 100 or more acicular particles 40 are identified at positions corresponding to ¼, ½, and ¾ of a dielectric layer width, by the same method used for identifying the acicular particles 40 described above. Among the identified acicular particles 40, a number ratio of acicular particles satisfying Expression I is determined. The same operation is performed for a plurality of samples, and an arithmetic average of the determined number ratios is defined as the amount of acicular particles satisfying Expression I. Note that the acicular particles 40 may be counted based on SEM images obtained from a plurality of dielectric layers and/or a plurality of fields of view.

The dielectric layers 11 may contain an additive in addition to the perovskite compound and the acicular particles 40 described above. Such an additive is not particularly limited and may be selected as appropriate depending on the intended purpose. Examples of the additive include: an elemental substance or a compound containing one or more elements selected from zirconium (Zr), magnesium (Mg), manganese (Mn), molybdenum (Mo), vanadium (V), chromium (Cr), and a rare-earth element selected from scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb); an elemental substance or a compound containing one or more elements selected from cobalt (Co), nickel (Ni), lithium (Li), boron (B), sodium (Na), potassium (K), and silicon (Si); and glass containing an oxide of one or more elements selected from cobalt, nickel, lithium, boron, sodium, potassium, and silicon.

The dielectric layers 11 may contain copper (Cu). When the dielectric layers 11 contain copper, the copper concentration in the dielectric layers 11 is preferably 0.1 atomic % or less to ensure the insulation properties of the dielectric layers 11.

A thickness (μm) of the dielectric layers 11 is 0.6 μm or less, and preferably ranges from 0.2 μm to 0.6 μm, inclusive. When the thickness of the dielectric layers 11 is 0.6 μm or less, the amount of acicular particles per layer required to exhibit high mechanical strength can be reduced. As a result, the dielectric characteristics can be improved, and both the mechanical strength and the electrical characteristics can be achieved. When the thickness of the dielectric layers 11 is 0.2 μm or more, the acicular particles are prevented from interfering with an internal electrode layer, and thus reliability is enhanced.

A method for measuring the thickness (μm) of the dielectric layers 11 is not particularly limited and may be selected as appropriate depending on the intended purpose. For example, the thickness may be evaluated based on cross-sectional observation of the multilayer ceramic capacitor 100. More specifically, the multilayer ceramic capacitor is polished along the X-axis direction or the Y-axis direction to expose a YZ plane or an XZ plane of the capacitance portion 14. In this case, the position of the plane exposed by polishing is preferably located near the center of the capacitance portion 14 in the X-axis direction or the Y-axis direction. An image of the exposed plane is captured by a laser microscope or the like, and approximately 5 to 10 dielectric layers 11 are selected from each of a central portion, an upper end portion, and a lower end portion in the Z-axis direction (the laminating direction of the dielectric layers 11), thereby selecting a total of approximately 15 to 20 dielectric layers 11. A thickness t (a length in the Z-axis direction) of each dielectric layer 11 is measured at portions corresponding to ¼, ½, and ¾ of a dielectric layer width, and an average value of the measured thicknesses may be taken as the thickness t (μm) of the dielectric layers 11. When images are captured using a laser microscope or the like, the images may be captured separately for the central portion, the upper end portion, and the lower end portion in the Z-axis direction (the laminating direction of the dielectric layers 11). Alternatively, the images may be captured separately for portions corresponding to ¼, ½, and ¾ of the dielectric layer width.

### (Internal Electrode Layer)

The internal electrode layers 12 contain a metal or an alloy as a main component. For example, the internal electrode layers 12 may contain, as the main component, a base metal (e.g., nickel (Ni) or tin (Sn)), or an alloy including such a base metal. Note that the internal electrode layers 12 may contain, as the main component, a noble metal (e.g., platinum (Pt), palladium (Pd), silver (Ag), or gold (Au)), or an alloy including such a noble metal. Among these, the internal electrode layers 12 preferably contain Ni to provide excellent electrical characteristics while reducing cost.

The main component of the first internal electrode layers 12a and the main component of the second internal electrode layers 12b may be the same or different.

The internal electrode layers 12 may optionally contain an additional metal element in addition to the main component metal. When the internal electrode layers 12 contain an additional metal element, the additional metal element may be, for example, a metal more noble than the main component metal of the internal electrode layers 12. More specifically, one or more elements selected from the group consisting of Au (gold), Sn (tin), Cr (chromium), Y (yttrium), In (indium), As (arsenic), Co (cobalt), Cu (copper), Ir (iridium), Mg (magnesium), Os (osmium), Pd (palladium), Pt (platinum), Re (rhenium), Rh (rhodium), Ru (ruthenium), Se (selenium), Te (tellurium), W (tungsten), and Zn (zinc) may be contained. For example, the internal electrode layers 12 may contain copper (Cu). When the internal electrode layers 12 contain Ni as the main component, Cu may form an alloy with Ni. When the internal electrode layers 12 contain copper, the interfacial resistance between the internal electrode layers and the dielectric layers increases, thereby prolonging the lifetime of the MLCC.

The copper concentration (atomic %) in the internal electrode layers 12 is not particularly limited and may be selected as appropriate depending on the intended purpose. The copper concentration is preferably 2.5 atomic % or less, more preferably 2 atomic % or less, still more preferably 1.5 atomic % or less, and particularly preferably 1 atomic % or less. When the copper concentration (atomic %) in the internal electrode layer 12 is set to 2.5 atomic % or less as described above, it is possible to prevent a decrease in continuity of the internal electrode layers 12, which would otherwise be caused by a reduction in a melting point of the internal electrode layers 12 due to an excessive amount of copper present in the internal electrode layers 12. Moreover, the copper concentration (atomic %) in the internal electrode layers 12 is preferably 0.2 atomic % or more, more preferably 0.3 atomic % or more, and still more preferably 0.5 atomic % or more, to improve the lifetime characteristics.

A method for measuring the copper concentration in the internal electrode layers 12 is not particularly limited and may be selected as appropriate depending on the intended purpose. For example, the copper concentration may be defined as an average value of the copper concentration (atomic %) within a region corresponding to the internal electrode layers 12 in a concentration distribution graph obtained from TEM-EDX analysis. When strict delineation of the boundary is required, the region of the internal electrode layer 12 may be defined as a region in which an oxygen concentration is less than 5 atomic %. Herein, the copper concentration refers to an atomic ratio of copper to all elements contained in the internal electrode layers 12.

A thickness of the internal electrode layers 12 is not particularly limited and may be selected as appropriate depending on the intended purpose. The thickness preferably ranges from 0.1 μm to 1.5 μm, inclusive, and more preferably ranges from 0.3 μm to 1.0 μm, inclusive.

When the thickness of the internal electrode layers 12 is 0.1 μm or more, the functionality as internal electrodes can be ensured. When the thickness of the internal electrode layer 12 is 1.5 μm or less, the electrostatic capacitance can be increased without changing the external dimensions of the multilayer ceramic capacitor by increasing the number of laminated layers of the capacitance portion 14. In other words, it is preferable that the thickness of the internal electrode layers 12 be 1.5 μm or less to obtain a smaller multilayer ceramic capacitor while maintaining equivalent performance. To enable an increase in the electrostatic capacitance by increasing the number of laminated layers, the thickness of the internal electrode layers 12 is preferably 0.5 μm or less, and more preferably 0.4 μm or less.

A method for measuring the thickness of the internal electrode layers 12 is not particularly limited and may be selected as appropriate depending on the intended purpose. For example, the thickness of the internal electrode layers 12 may be measured by the same method used for measuring the thickness of the dielectric layers 11.

### [Method for Manufacturing Multilayer Ceramic Capacitor]

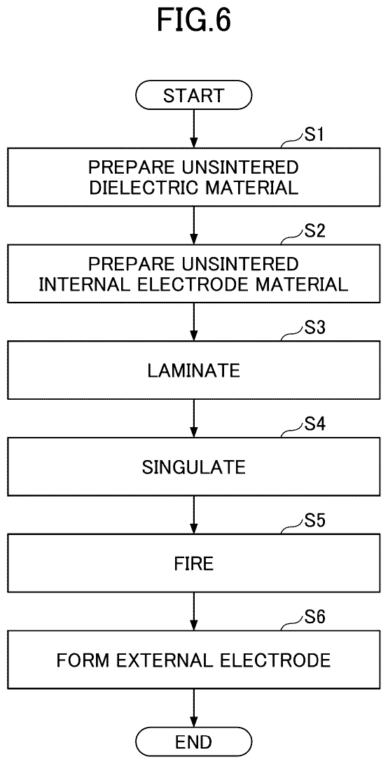

Next, a method for manufacturing the above-mentioned multilayer ceramic capacitor 100 will be described. According to an embodiment of the present disclosure, a method for manufacturing a multilayer ceramic capacitor including an element body in which a dielectric layer and an internal electrode layer are alternately laminated in a first axis direction and the dielectric layer includes a perovskite compound represented by a general formula ABO₃ and acicular particles containing silicon (Si) and aluminum (Al), includes: a lamination step of alternately laminating an unsintered dielectric material to form the dielectric layer and an unsintered internal electrode material to form the internal electrode layer to obtain a multilayer body; and a firing step of firing the multilayer body. In the method, a thickness of the dielectric layer is 0.6 μm or less, and a proportion of the acicular particles satisfying Expression I to a total of the acicular particles ranges from 45% to 65%, inclusive. FIG. 6 is a flowchart illustrating, as an example, a method for manufacturing the multilayer ceramic capacitor 100 according to an embodiment.

$$0 ° \leq θ < 30 ° \qquad Expression I$$

where θ is an acute angle formed between a line segment parallel to a direction perpendicular to the first axis direction and a line segment parallel to a longitudinal direction of each of the acicular particles, in a cross-sectional view of the multilayer ceramic capacitor taken along the first axis direction.

### (Preparation Step of Unsintered Dielectric Material (S1))

In a preparation step of an unsintered dielectric material (S1), a ceramic green sheet, which is an unsintered dielectric material to be fired into the dielectric layers 11, is prepared.

First, a dielectric-layer-forming powder is prepared. The dielectric-layer-forming powder includes a ceramic powder and acicular particles containing silicon (Si) and aluminum (Al).

The ceramic powder may be a powder of the ceramic material described above for the dielectric layers 11 of the multilayer ceramic capacitor 100. Accordingly, the ceramic powder may include a powder of a perovskite compound represented by the general formula ABO₃, and preferably includes barium titanate.

A predetermined additive may be added to the dielectric-layer-forming powder depending on the intended purpose. The dielectric-layer-forming powder is wet-mixed with or without the additive, dried, and then pulverized. Thereafter, a binder (e.g., a polyvinyl butyral (PVB) resin), an organic solvent (e.g., ethanol and toluene), and a plasticizer are added and wet-mixed to prepare a dielectric-layer-forming slurry. The resulting dielectric-layer-forming slurry is applied onto a base such as a polyethylene terephthalate (PET) film by a die coater method, a doctor blade method, or the like, and then dried to obtain a ceramic green sheet (unsintered dielectric material).

A method for applying the dielectric-layer-forming slurry is preferably a doctor blade method to facilitate control of the amount of acicular particles satisfying Expression I. It is also preferable to adjust the viscosity of the dielectric-layer-forming slurry in accordance with the dielectric-layer-forming slurry application method. For example, when the dielectric-layer-forming slurry application method is a doctor blade method, the viscosity of the dielectric-layer-forming slurry preferably ranges from 0.1 Pa·s to 10.0 Pa·s, inclusive, at room temperature and at a shear rate of 1.0 s⁻¹, to facilitate control of the amount of acicular particles satisfying Expression I. The viscosity of the dielectric-layer-forming slurry can be measured with, for example, a viscometer.

The amount of the acicular particles satisfying Expression I can be controlled, for example, based on the amount of acicular particles 40 contained in the dielectric-layer-forming powder used to form the dielectric layers 11, the viscosity of a dielectric-layer-forming slurry, the coating speed of the dielectric-layer-forming slurry, and the thickness of a ceramic green sheet. When the coating speed of the dielectric-layer-forming slurry is high, a shearing force is increased, and thus control of an orientation of the acicular particles 40 to a direction parallel to the base is facilitated. By reducing the thickness of the ceramic green sheet, that is, by narrowing a gap of a discharge port of a coating apparatus, the dielectric-layer-forming slurry passes through a narrow gap, and thus control of an orientation of the acicular particles 40 to a direction parallel to the base is facilitated.

The specific conveying speed for the base and the specific discharge speed of the dielectric-layer-forming slurry vary depending on the coating apparatus. For example, when the conveying speed for the base is set to 1.5 times or more of a normal conveying speed, and the discharge speed of the dielectric-layer-forming slurry is set to 1.5 times or more of a normal discharge speed in accordance with the conveying speed for the base, the coating speed of the dielectric-layer-forming slurry can be increased to 1.5 times the normal coating speed while maintaining the thickness of the ceramic green sheet and increasing the shearing force. When the conveying speed for the base is set to 2 times or more of the normal conveying speed, and the discharge speed of the dielectric-layer-forming slurry is set to 2 times or more of the normal discharge speed in accordance with the conveying speed for the base, the coating speed of the dielectric-layer-forming slurry can be increased to 2 times or more of the normal coating speed.

### (Preparation Step of Unsintered Internal Electrode Material (S2))

In a preparation step of an unsintered internal electrode material (S2), an unsintered internal electrode material to form the internal electrode layers 12, that is, the first internal electrode layers 12a and the second internal electrode layers 12b, is prepared. A metal serving as a main component of the unsintered internal electrode material may be the same metal material as that described above for the internal electrode layers 12 of the multilayer ceramic capacitor 100, and may be, for example, a base metal (e.g., Ni or Sn) or an alloy containing such metals. Alternatively, the metal material may be a noble metal (e.g., Pt, Pd, Ag, or Au), or an alloy containing such metals. Among these, the metal material preferably contains Ni and more preferably contains Ni as a main component to provide excellent electrical characteristics while reducing cost.

The metal material may optionally contain an additional metal element in addition to the main component metal. When the metal material contains an additional metal element, the additional metal element may be, for example, a metal more noble than the main component metal of the internal electrode layers 12. More specifically, one or more elements selected from the group consisting of Au (gold), Sn (tin), Cr (chromium), Y (yttrium), In (indium), As (arsenic), Co (cobalt), Cu (copper), Ir (iridium), Mg (magnesium), Os (osmium), Pd (palladium), Pt (platinum), Re (rhenium), Rh (rhodium), Ru (ruthenium), Se (selenium), Te (tellurium), W (tungsten), and Zn (zinc) may be contained. For example, when the main component metal of the internal electrode layers 12 is Ni, Cu may be added. Then, the metal material after the addition of Cu, an organic binder, and a solvent are kneaded to obtain a metal paste (unsintered internal electrode material). Note that Cu may be added after the metal paste is prepared from the main component metal material. Cu is preferably added in the form of an oxide to facilitate diffusion into an intermediate region during the firing step. Examples of the oxide of Cu include copper oxide.

The addition amount and the size of the acicular particles in the unsintered internal electrode material can be adjusted so that the proportion of the acicular particles satisfying Expression I to the total acicular particles ranges from 45% to 65%, inclusive. By adjusting the addition amount and the size of the acicular particles as described above, the strength of the multilayer ceramic capacitor can be improved, and the electrical characteristics such as lifetime and electrostatic capacitance can also be improved. Moreover, penetration of the acicular particles through an internal electrode layer, which could occur in multilayer ceramic capacitors in the related art, can be suppressed, and thus characteristics such as yield, short-circuit rate, and lifetime are improved. Thus, according to the present embodiment, the multilayer ceramic capacitor 100 with high strength and excellent electrical characteristics can be manufactured.

A ceramic powder may be added as a co-material to the metal paste (unsintered internal electrode material). The main component of the ceramic powder is not particularly limited, but is preferably the same as that of the ceramic powder used in the preparation step of the unsintered dielectric material (S1). The ceramic powder may be added as a co-material during kneading of the metal paste.

### (Lamination Step (S3))

In a lamination step (S3), the resulting metal paste in the preparation step of the unsintered internal electrode material (S2) is printed on a surface of the ceramic green sheet obtained in the preparation step of the unsintered dielectric material (S1) by screen printing, gravure printing, or the like. Accordingly, a first internal electrode pattern to form the first internal electrode layer 12a and a second internal electrode pattern to form the second internal electrode layer 12b are arranged on the surface of the ceramic green sheet. Note that a method for forming the internal electrode patterns is not limited to printing, and may alternatively be performed by plating, vacuum deposition, sputtering, chemical vapor deposition (CVD), or the like using a mask.

The ceramic green sheet on which the metal paste has been applied is then laminated such that the internal electrode layers 12 are alternately led out to the pair of external electrodes 20a and 20b arranged in the longitudinal direction (X-axis direction) of the dielectric layers 11. This lamination may be performed by using a known technique. For example, in order to form the side margins 16, which are outer regions in the Y-axis direction in the capacitance portion 14, on the sides where the internal electrode layers 12 are not led out, an unsintered dielectric material may be arranged in peripheral regions in which the internal electrode patterns are not printed with the metal paste. The ceramic green sheet on which the metal paste is printed may be regarded as a lamination unit, and the number of lamination units may be, for example, from 100 layers to 500 layers.

Subsequently, a cover sheet, which is an unsintered cover material for forming cover layers, is laminated on the upper and lower sides of the multilayer body in which the ceramic green sheets and the internal electrode patterns are laminated, that is, on the opposite sides of the multilayer body in the laminating direction (Z-axis direction), to obtain a laminated assembly. The cover sheet may be formed mainly using a ceramic powder by the same method used for forming the unsintered dielectric material for the dielectric layers. Alternatively, the cover sheet may be formed from the same material as the unsintered dielectric material for forming the dielectric layers. The number of laminated cover sheets may be, for example, from 2 layers to 10 layers on each side.

The resulting laminated assembly is pressed in the laminating direction (Z-axis direction) to obtain a pressed body.

### (Singulation Step (S4))

The pressed body may be cut into individual pieces having a predetermined size by dicing using a dicer, laser cutting, or the like. A singulation method can employ a known technique as appropriate.

### (Firing Step (S5))

In a firing step (S5), the individual pieces of the laminated assembly are fired. The firing conditions are not particularly limited and may be selected as appropriate depending on the intended purpose. However, the hydrogen concentration preferably ranges from 0.03 vol % to 1.0 vol %, inclusive, and more preferably ranges from 0.05 vol % to 0.3 vol %. Note that the remainder of the reducing atmosphere, other than hydrogen, is nitrogen or argon. In the firing step (S5), Cu added in advance to the unsintered materials segregates or diffuses at the interface, and an intermediate region is formed.

The firing temperature in the firing step (S5) preferably ranges from 1,000° C. to 1,250° C., inclusive, and more preferably ranges from 1,150° C. to 1,300° C., inclusive. The firing time in the firing step (S5) may range from 30 minutes to 2 hours, inclusive.

### (External Electrode Forming Step (S6))

In an external electrode forming step, the first external electrode 20a and the second external electrode 20b can be formed by plating or the like. Accordingly, the multilayer ceramic capacitor 100 described above is completed.

### EXAMPLES

Hereinafter, the present disclosure will be described more specifically based on Examples.

### Example 1

### [Production of Multilayer Ceramic Capacitor]

A source powder and an ethanol solution were ball-milled with zirconia beads. Thereafter, the zirconia beads are separated by sieving or the like, and the mixture was dried at 100° C. to remove ethanol, thereby obtaining a mixed powder. The mixed powder was then subjected to heat treatment under an air atmosphere at a temperature of 1,150° C. for a heat retention time of 2 hours to obtain acicular particles (L: 0.15 μm, W: 0.02 μm). Materials contained in the source powder are as follows.

$$- Source Powder -$$

$${SiO}_{2} : {Al}_{2} {O}_{3} : {TiO}_{2} : {CaCO}_{3} : {Na}_{2} {CO}_{3} : {K}_{2} {CO}_{3} = 1 : 1.2 : 0.01 : 0.002 : 0.005 : 0.003 ( mol \% )$$

A polyvinyl butyral (PVB) resin, a solvent, a plasticizer, a sintering aid powder that is a Si compound, and an additive such as a rare-earth element were added to a dielectric-layer-forming powder composed of barium titanate and acicular particles, and were wet-mixed to prepare a ceramic slurry. The addition amount of acicular particles was adjusted to 1.5 mass % relative to the total amount of barium titanate. The viscosity of the ceramic slurry was measured using a viscometer under conditions of room temperature and a shearing rate of 1 s⁻¹, and was found to be 0.65 Pa·s. The ceramic slurry was applied onto a base film using a doctor blade to form a dielectric green sheet so that the thickness of the dielectric layer after sintering was 0.50 μm.

Cu was added to nickel powder in the form of copper oxide (CuO) powder and mixed to prepare a mixed powder. A polyvinyl butyral (PVB) resin, a solvent, and a plasticizer were added to the mixed powder and kneaded to obtain a metal paste for forming internal electrode layers. The metal paste was printed on the dielectric green sheet to form internal electrode layer patterns.

A multilayer body was formed by laminating 500 dielectric green sheets on which the metal paste was printed, with dielectric green sheets serving as cover layers arranged on opposite sides in the lamination direction.

The resulting multilayer body was pressed and then cut into a predetermined size to obtain singulated green chips. The resulting green chips were subjected to a debinding treatment in an N₂ atmosphere, and the metal paste serving as a base layer for external electrodes was applied by dipping. Subsequently, the green chips were placed in a firing furnace, and firing was performed for 10 minutes while raising the temperature of the firing furnace (firing temperature) to 1,200° C. in an atmosphere having an H₂ concentration of 0.1 vol % and an N₂ concentration of 99.9 vol %. After firing, external electrodes were formed on the green chips by plating to obtain multilayer ceramic capacitors (MLCCs) having dimensions of 1.0 mm×0.5 mm×0.5 mm.

### [Measurement of Amount of Acicular Particles Satisfying Expression I]

The multilayer ceramic capacitor was polished along the X-axis direction to expose a plane near the center of the YZ plane of the capacitance portion 14. On the exposed plane, approximately three dielectric layers 11 were selected from each of a central portion, an upper end portion, and a lower end portion in the Z-axis direction (the laminating direction of the dielectric layers 11), thereby selecting nine dielectric layers 11 in total. In each selected dielectric layer 11, 100 or more acicular particles 40 were identified at positions corresponding to ¼, ½, and ¾ of a dielectric layer width, by a method for identifying the acicular particles 40. Among the identified acicular particles 40, a number ratio of acicular particles satisfying Expression I was determined. The same operation was performed for a plurality of samples, and an arithmetic average of the determined number ratios was defined as the amount of acicular particles satisfying Expression I. Note that the method for identifying the acicular particles 40 was as follows. A partial cross section including an internal electrode layer in a YZ plane or an XZ plane of the multilayer ceramic capacitor was observed using a scanning electron microscope (SEM; SU8220 available from Hitachi High-Tech Corporation) capable of identifying a composition of a sample based on a backscattered electron image. From a contrast difference in the backscattered electron image, acicular particles having a composition different from that of the dielectric material were identified.

### [Evaluation of Strength]

### <Number of Cracked Samples>

The produced multilayer ceramic capacitors were visually inspected to determine whether a crack was present after firing. The number of samples evaluated was 100, and the number of samples in which a crack was observed is shown in Table 1.

### <Number of Short-Circuited Samples>

A DC voltage of 1 V was applied to the external electrodes of each multilayer ceramic capacitor in which no crack was present among the 100 produced multilayer ceramic capacitors, and samples having an electrical resistance of less than 1 kW between the external electrodes were defined as short-circuited samples. The results are shown in Table 1.

### <Yield>

A ratio of the number of multilayer ceramic capacitors in which neither a crack nor a short circuit was present to the total number of 100 produced multilayer ceramic capacitors was defined as a yield, and the results are shown in Table 1. A multilayer ceramic capacitor having a yield of 100% was determined as “pass,” and other multilayer ceramic capacitors were determined as “fail.”

### <Evaluation of Failure Rate in Flexural Test>

Among the produced multilayer ceramic capacitors, 100 multilayer ceramic capacitors in which neither a crack nor a short circuit was present were prepared. A three-point bending tester was used. Each multilayer ceramic capacitor was fixed on a stainless steel plate with an epoxy resin, and a displacement of 3 mm was applied from the stainless steel side 100 times. The flexural test was conducted on 100 samples, and the presence or absence of a crack was evaluated by visual observation to calculate the failure rate in the flexural test. The results are shown in Table 1. A multilayer ceramic capacitor having a failure rate of 0% in the flexural test was determined as “pass,” and other multilayer ceramic capacitors were determined as “fail.”

### [Evaluation of Electrical Characteristics]

### <Electrostatic Capacitance>

Among the produced multilayer ceramic capacitors, each multilayer ceramic capacitor in which neither a crack nor a short circuit was present was left at 150° C. for 1 hour and then left under standard conditions (temperature: 25° C., pressure: 1 atm) for 24 hours. Thereafter, the electrostatic capacitance (μF) was measured by using an LCR meter (HP4284A available from Keysight Technologies) under conditions of a voltage of 0.5 V and a frequency of 1 kHz. The results are shown in Table 1. Note that the electrostatic capacitance of each multilayer ceramic capacitor is expressed relative to that of the multilayer ceramic capacitor of Comparative Example 1, which is defined as 100. A multilayer ceramic capacitor having an electrostatic capacitance of 95% or more was determined to be acceptable. A multilayer ceramic capacitor having an electrostatic capacitance of 105% or more was determined as “Excellent,” a multilayer ceramic capacitor having an electrostatic capacitance of 100% or more and less than 105% was determined as “Good,” a multilayer ceramic capacitor having an electrostatic capacitance of 95% or more and less than 100% was determined as “Fair,” and other multilayer ceramic capacitors were determined as “Poor.”

### <Lifetime Characteristics>

The lifetime characteristics were evaluated by a highly accelerated life test (HALT). A voltage of 9.0 V was applied at 150° C. to each of 20 produced multilayer ceramic capacitors in which neither a cracks nor a short circuit was present, and a leakage current was measured over time. A time at which 50% of the samples reached a leakage current of 2,000 μA was recorded as the 50% HALT lifetime value. The results are shown in Table 1. Note that the lifetime of each multilayer ceramic capacitor is expressed relative to that of the multilayer ceramic capacitor of Comparative Example 1, which is defined as 100. A multilayer ceramic capacitor having a lifetime of 100% or more was determined to be acceptable. A multilayer ceramic capacitor having a lifetime of 150% or more was determined as “Excellent,” a multilayer ceramic capacitor having a lifetime of 100% or more and less than 150% was determined as “Good,” and other multilayer ceramic capacitors were determined as “Poor.”

### Examples 2 to 4 and Comparative Examples 1 to 5

As shown in Table 1, each multilayer ceramic capacitor was produced and evaluated in the same manner as in Example 1, except that a composition of a dielectric-layer-forming powder was changed. In Comparative Example 2, spherical particles having an average particle diameter of 30 nm were used instead of the acicular particles. The spherical particles were synthesized by subjecting a source powder, which is obtained by mixing SiO₂ and Al₂O₃ at a molar ratio of 1:1.2, to heat treatment at 800° C. for 2 hours. The results are shown in Table 1.

TABLE 1

| | | THICKNESS OF | | | | | |
|---|---|---|---|---|---|---|---|
| | | DIELECTRIC | | AMOUNT OF | EVALUATION OF STRENGTH | | |
| | SHAPE OF | LAYER | | ACICULAR | | NUMBER OF | |
| | ALUMINO- | AFTER | VISCOSITY | PARTICLES | NUMBER OF | SHORT- | |
| | SILICATE | SINTERING | OF SLURRY | SATISFYING | CRACKED | CIRCUITED | |
| | PARTICLES | (μm) | Pa · s | EXPRESSION I | SAMPLES | SAMPLES | YIELD |
| EXAMPLE 1 | ACICULAR | 0.50 | 0.65 | 64.2% | 0 | 0 | 100% |
| EXAMPLE 2 | ACICULAR | 0.50 | 0.52 | 55.3% | 0 | 0 | 100% |
| EXAMPLE 3 | ACICULAR | 0.50 | 0.65 | 46.8% | 0 | 0 | 100% |
| EXAMPLE 4 | ACICULAR | 0.60 | 0.65 | 62.8% | 0 | 0 | 100% |
| COMPARATIVE | ACICULAR | 0.50 | 0.43 | 38.0% | 0 | 13 | 87% |
| EXAMPLE 1 | | | | | | | |
| COMPARATIVE | SPHERICAL | 0.50 | 0.43 | 0.0% | 17 | 1 | 82% |
| EXAMPLE 2 | | | | | | | |
| COMPARATIVE | ACICULAR | 0.50 | 0.65 | 77.3% | 18 | 3 | 79% |
| EXAMPLE 3 | | | | | | | |
| COMPARATIVE | ACICULAR | 0.65 | 0.64 | 61.0% | 3 | 1 | 96% |
| EXAMPLE 4 | | | | | | | |
| COMPARATIVE | ACICULAR | 0.75 | 0.65 | 63.0% | 6 | 1 | 93% |
| EXAMPLE 5 | | | | | | | |

| | | | | ELECTRICAL CHARACTERISTIC | | | |
|---|---|---|---|---|---|---|---|
| | EVALUATION OF STRENGTH | | | EVALUATION | | | |
| | | FAILURE | | ELECTRO- | | | |
| | | RATE IN | | STATIC | | | |
| | DETERMI- | FLEXURAL | DETERMI- | CAPACI- | DETERMI- | LIFE- | DETERMI- |
| | NATION | TEST | NATION | TANCE | NATION | TIME | NATION |
| EXAMPLE 1 | PASS | 0/100 | PASS | 101 | GOOD | 188 | EXCELLENT |
| EXAMPLE 2 | PASS | 0/100 | PASS | 109 | EXCELLENT | 168 | EXCELLENT |
| EXAMPLE 3 | PASS | 0/100 | PASS | 100 | GOOD | 147 | GOOD |
| EXAMPLE 4 | PASS | 0/100 | PASS | 96 | FAIR | 185 | EXCELLENT |
| COMPARATIVE | FAIL | 0/100 | PASS | 100 | GOOD | 100 | GOOD |
| EXAMPLE 1 | | | | | | | |
| COMPARATIVE | FAIL | 11/100 | FAIL | 102 | GOOD | 184 | EXCELLENT |
| EXAMPLE 2 | | | | | | | |
| COMPARATIVE | FAIL | 0/100 | PASS | 96 | FAIR | 168 | EXCELLENT |
| EXAMPLE 3 | | | | | | | |
| COMPARATIVE | FAIL | 1/100 | FAIL | 73 | POOR | 182 | EXCELLENT |
| EXAMPLE 4 | | | | | | | |
| COMPARATIVE | FAIL | 2/100 | FAIL | 48 | POOR | 190 | EXCELLENT |
| EXAMPLE 5 | | | | | | | |

As shown in Table 1, the multilayer ceramic capacitors of Examples 1 and 4, in which the amount of acicular particles satisfying Expression I ranges from 60% to 65%, inclusive, had no defects during sintering and exhibited favorable electrical characteristics. The multilayer ceramic capacitors of Example 2, in which the amount of acicular particles satisfying Expression I ranges from 55% to 65%, inclusive, and of Example 3, in which the amount of acicular particles satisfying Expression I ranges from 45% to 65%, inclusive, were slightly inferior to the multilayer ceramic capacitors of Example 1, but still exhibited favorable electrical characteristics.

In contrast, the multilayer ceramic capacitors of Comparative Example 1, in which the amount of acicular particles satisfying Expression I was less than 45%, exhibited short-circuit failures after firing, resulting in inferior element body strength. The multilayer ceramic capacitors of Comparative Example 2, which did not contain acicular particles, and the multilayer ceramic capacitors of Comparative Example 3, in which the amount of acicular particles satisfying Expression I exceeded 65%, exhibited a crack after firing, and thus exhibited significantly inferior element body strength. The multilayer ceramic capacitors of Comparative Example 2 also exhibited inferior flexural strength. The multilayer ceramic capacitors of Comparative Examples 4 and 5, in which a thickness of the dielectric layers exceeded 0.6 μm, exhibited inferior strength after firing and inferior flexural strength. In addition, the electrostatic capacitance values were reduced due to an increase in the thickness of the dielectric layers.

According to an aspect of the present disclosure, a multilayer ceramic capacitor with high strength and excellent electrical characteristics can be provided.

Although the embodiments have been described in detail above, the present disclosure is not limited to the above-described embodiments. Various changes, modifications, substitutions, additions, deletions, combinations, and the like can be made to the above embodiments within the scope of the appended claims.

Aspects of the present disclosure are, for example, as follows.

<1>

The multilayer ceramic capacitor includes:
an element body in which a dielectric layer and an internal electrode layer are alternately laminated in a first axis direction, in which
the dielectric layer includes: a perovskite compound represented by a general formula ABO₃; and acicular particles containing silicon (Si) and aluminum (Al),
a thickness of the dielectric layer is 0.6 μm or less, and
a proportion (number ratio) of acicular particles satisfying Expression I to a total of the included acicular particles ranges from 45% to 65%, inclusive.

$$0 ° \leq θ < 30 ° \qquad Expression I$$

where θ is an acute angle formed between a line segment parallel to a direction perpendicular to the first axis direction and a line segment parallel to a longitudinal direction of each of the acicular particles, in a cross-sectional view of the multilayer ceramic capacitor taken along the first axis direction.

<2>

The multilayer ceramic capacitor according to <1>, in which the thickness of the dielectric layer is 0.2 μm or more.

<3>

The multilayer ceramic capacitor according to <1> or <2>, in which the proportion of the acicular particles satisfying Expression I to the total of the included acicular particles is from 55% to less than 65%.

<4>

The multilayer ceramic capacitor according to any one of <1> to <3>, in which the perovskite compound includes barium titanate.

What is claimed is:

1. A multilayer ceramic capacitor, comprising:
an element body in which a dielectric layer and an internal electrode layer are alternately laminated in a first axis direction, wherein
the dielectric layer includes: a perovskite compound represented by a general formula ABO₃; and acicular particles containing silicon (Si) and aluminum (Al),
a thickness of the dielectric layer is 0.6 μm or less, and
a proportion (number ratio) of acicular particles satisfying Expression I to a total of the included acicular particles ranges from 45% to 65%, inclusive,
$$0 ° \leq θ < 30 ° \qquad Expression I$$
where θ is an acute angle formed between a line segment parallel to a direction perpendicular to the first axis direction and a line segment parallel to a longitudinal direction of each of the acicular particles, in a cross-sectional view of the multilayer ceramic capacitor taken along the first axis direction.

2. The multilayer ceramic capacitor according to claim 1, wherein
the thickness of the dielectric layer is 0.2 μm or more.

3. The multilayer ceramic capacitor according to claim 1, wherein
the proportion of the acicular particles satisfying Expression I to the total of the included acicular particles ranges from 55% to 65%, inclusive.

4. The multilayer ceramic capacitor according to claim 1, wherein
the perovskite compound includes barium titanate.
